(19) United States
(12) Patent Application Publication
(10) Pub. No.: US 2020/0207967 A1
(43) Pub. Date: Jul. 2, 2020

(54) EP(D)M-EVM WIPER RUBBER WITH IMPROVED COLD FLEXIBILITY

(71) Applicant: Robert Bosch GmbH, Stuttgart (DE)

(72) Inventors: Nicolaas Gotzen, Kortenberg (BE); Eric Pieters, Simpelveld (NL); Joke Vandenbergh, Tongeren (BE)

(21) Appl. No.: 16/728,092

(22) Filed: Dec. 27, 2019

(30) Foreign Application Priority Data
Jan. 2, 2019 (DE) 10 2019 200 002.9

(51) Int. Cl. C08L 23/16; B60S 1/38

(52) U.S. Cl. CPC C08L 23/16; B60S 1/38; B60S 2001/3829; C08L 2205/03; C08L 2205/035; C08L 2205/025

(57) ABSTRACT

A wiper rubber (10) for a wiper blade, especially for a windshield wiper, with an elastomer material comprising a polymer blend composed of at least one ethylene-propylene-diene rubber and/or at least one ethylene-propylene rubber, and at least one ethylene-vinyl acetate copolymer is disclosed. In order to provide a wiper rubber that has improved wiping quality and improved running properties, especially reduced or zero running noise, such as humming, whistling, squeaking, smacking, turnover noises, et cetera, both at moderate and especially at cold outside temperature, and especially also over a broad frequency range customary in wiper operation, the at least one ethylene-vinyl acetate copolymer, based on the total weight of the at least one ethylene-vinyl acetate copolymer, comprises a vinyl acetate content within a range from ≥40% by weight to ≤90% by weight, where the polymer blend, based on the total weight of the polymers in the polymer blend, comprises ≥0.1% by weight to ≤30% by weight of the at least one ethylene-vinyl acetate copolymer.

### BACKGROUND OF THE INVENTION

The present invention relates to a wiper rubber for a wiper blade, especially for a windshield wiper, and to a wiper blade equipped therewith.

Wiper rubbers for wiper blades, by way of example for windshield wipers, typically have a wiper lip and a securing section. The wiper lip is brought into contact here with the surface to be wiped therewith, windowpane by way of example. The securing section can secure the wiper blade, for example on a wiper blade rail.

Documents DE 10 2013 202 108 A1, KR 2003-0009904 A, DE 10 2009 026 441 A1, DE 10 2016 213 862 A1. and W 2014-28602 A relate to wiper rubbers for wiper blades, by way of example for windshield wipers.

### SUMMARY OF THE INVENTION

The present invention provides a wiper rubber for a wiper blade. In particular, the wiper rubber may be designed for a wiper blade of a windshield wiper, by way of example for a vehicle, for example for an automobile.

The wiper rubber especially comprises an elastomer material comprising a polymer blend composed of at least one ethylene-propylene-diene rubber and/or at least one ethylene-propylene rubber, and at least one ethylene-vinyl acetate copolymer.

The at least one ethylene-vinyl acetate copolymer here especially comprises, based on the total weight of the at least one ethylene-vinyl acetate copolymer, a vinyl acetate content within a range from >40% by weight to <90% by weight.

The polymer blend here especially comprises, based on the total weight of the polymers in the polymer blend, ≥0.1% by weight to <30% by weight of the at least one ethylene-vinyl acetate copolymer.

It has been found that, in the case of addition of at least one ethylene-vinyl acetate copolymer having a vinyl acetate content based on the total weight of the at least one ethylene-vinyl acetate copolymer within a range from ≥45% by weight to ≤85% by weight, it is possible at moderate outside temperatures to reduce or prevent unwanted running noise, such as humming, whistling, squeaking, smacking, turnover noises, et cetera, but it is not possible to achieve sufficiently good cold flexibility of the wiper rubber in the case of addition of a high amount of ≥30% by weight, by way of example to ≤60% by weight, based on the total weight of the polymers in the polymer blend, of the at least one ethylene-vinyl acetate copolymer. The effects of this may in turn be that the wiping quality of the wiper rubber is impaired at cold outside temperatures, and unwanted running noise, such as humming, whistling, squeaking, smacking, turnover noises, et cetera, cannot be sufficiently reduced or prevented at cold outside temperatures.

In the context of the present invention, however, it has been found that cold flexibility falls with a rising amount of the at least one ethylene-vinyl acetate copolymer and with a rising vinyl acetate content in the at least one ethylene-vinyl acetate copolymer, and glass transition temperature rises with a rising amount of the at least one ethylene-vinyl acetate copolymer and with a rising vinyl acetate content in the at least one ethylene-vinyl acetate copolymer.

Moreover, in the context of the present invention, it has been found that, surprisingly, even the addition of a relatively small amount, namely of <30% by weight, based on the total weight of the polymers in the polymer blend, of at least one ethylene-vinyl acetate copolymer having a vinyl acetate content based on the total weight of the at least one ethylene-vinyl acetate copolymer within a range from ≥40% by weight to ≤90% by weight can improve the damping properties, especially with maintenance of sufficiently good cold flexibility, and hence the running properties of the wiper rubber can be improved and, in particular, unwanted running noise, such as humming, whistling, squeaking, smacking, turnover noises, can be reduced or prevented over a broad temperature range including both moderate and especially cold outside temperatures and, by way of example, also over a broad frequency range customary in wiping operation. In this way, it is possible, by way of example, to achieve cold flexibility which is higher than in the case of addition of a large amount of ≥30% by weight, by way of example to ≤60% by weight, of the at least one ethylene-vinyl acetate copolymer and is at least roughly comparable with the cold flexibility of polymer blends composed of ethylene-propylene-diene rubber and/or ethylene-propylene rubber, especially in pure form. Moreover, it is thus advantageously possible to improve the wiping quality of the wiper rubber over a broad temperature range including both moderate and especially cold outside temperatures, and, by way of example, also over a broad frequency range customary in wiping operation.

Overall, it is thus advantageously possible to provide a wiper rubber for a wiper blade, especially for a windshield wiper, having improved wiping quality and improved running properties, especially reduced or zero running noise, such as humming, whistling, squeaking, smacking, turnover noises, et cetera, both at moderate and especially at cold outside temperatures, and especially also over a broad frequency range customary in wiping operation.

In the context of one embodiment, the polymer blend, based on the total weight of the polymers in the polymer blend, comprises ≥0.1% by weight to ≤29% by weight or ≤28.6% by weight or ≤28% by weight or ≤27% by weight or ≤26% by weight of the at least one ethylene-vinyl acetate copolymer. For example, the polymer blend, based on the total weight of the polymers in the polymer blend, may comprise ≥1% by weight to ≤25% by weight or ≤24% by weight or ≤23% by weight or ≤22% by weight or ≤21% by weight of the at least one ethylene-vinyl acetate copolymer. More particularly, the polymer blend, based on the total weight of the polymers in the polymer blend, may comprise ≥2% by weight to ≤20% by weight of the at least one ethylene-vinyl acetate copolymer. For example, the polymer blend, based on the total weight of the polymers in the polymer blend, may comprise ≥2% by weight or ≥3% by weight or ≥4% by weight or ≥5% by weight to ≤19% by weight or ≤18% by weight or ≤17% by weight or ≤16% by weight or ≤15% by weight, for example ≥2% by weight to ≤15% by weight or <15% by weight, of the at least one ethylene-vinyl acetate copolymer.

In the context of a further embodiment, the polymer blend further comprises at least one further rubber.

In the context of a further embodiment, the at least one further rubber comprises or is, or the polymer blend further comprises, natural rubber (NR) and/or at least one synthetic rubber. For example, at least one further rubber or the polymer blend may further comprise natural rubber (NR) and/or butadiene rubber (BR) and/or styrene-butadiene rubber (SBR) and/or isoprene rubber (IR). For instance, it is possible to improve processibility, by way of example extrudability, especially with maintenance of sufficiently good cold flexibility and wiping quality and of sufficiently good damping qualities and running properties, by way of example sufficiently good running noise reduction, especially over a broad temperature and frequency range, which can be especially advantageous if the wiping rubber is in the form of a hollow profile.

As the case may be, the addition of the at least one further rubber, by way of example of natural rubber and/or butadiene rubber and/or styrene-butadiene rubber and/or isoprene rubber, may also enable an increase in the vinyl acetate content of the at least one ethylene-vinyl acetate copolymer, based on the total weight of the at least one ethylene-vinyl acetate copolymer, for example from a range from ≥40% by weight to ≤60% by weight, by way of example from ≥50% by weight to ≤60% by weight (in the absence of NR/BR/SBR/IR), for example to a range from ≥60% by weight to ≤90% by weight, by way of example from ≥65% by weight to ≤90% by weight, for example from ≥70% by weight to ≤80% by weight (in the presence of NR/BR/SBR), while maintaining sufficient cold flexibility.

For example, the at least one further natural rubber may comprise or be natural rubber (NR) and/or butadiene rubber (BR) and/or styrene-butadiene rubber (SBR), especially natural rubber (NR) and/or butadiene rubber (BR), for example natural rubber (NR).

For example, the at least one ethylene-vinyl acetate copolymer, based on the total weight of the at least one ethylene-vinyl acetate copolymer, may include a vinyl acetate content within a range from ≥45% by weight to ≤90% by weight.

in the context of a further embodiment, the at least one ethylene-vinyl acetate copolymer, based on the total weight of the at least one ethylene-vinyl acetate copolymer, may include a vinyl acetate content within a range from ≥50% by weight to ≤90% by weight. More particularly, the at least one ethylene-vinyl acetate copolymer, based on the total weight of the at least one ethylene-vinyl acetate copolymer, may include a vinyl acetate content within a range from ≥60% by weight to ≤90% by weight. By way of example, the at least one ethylene-vinyl acetate copolymer, based on the total weight of the at least one ethylene-vinyl acetate copolymer, may have a vinyl acetate content within a range from ≥65% by weight or ≥70% by weight to ≤90% by weight. For example, the at least one ethylene-vinyl acetate copolymer, based on the total weight of the at least one ethylene-vinyl acetate copolymer, may have a vinyl acetate content within a range from ≥65% by weight to ≤90% by weight or optionally up to ≤85% by weight, by way of example from ≥70% by weight to ≤80% by weight. An increase in the vinyl acetate content in the at least one ethylene-vinyl acetate copolymer can advantageously improve the damping properties and hence the running noise reduction and wiping quality. Moreover, an increase in the vinyl acetate content in the at least one ethylene-vinyl acetate copolymer in turn advantageously enables a reduction in the amount of the at least one ethylene-vinyl acetate copolymer in the polymer blend and hence in turn maintenance or improvement of the cold flexibility.

It is possible here for the at least one ethylene-vinyl acetate copolymer to be either one vinyl acetate copolymer having a vinyl acetate content based on the total weight of the ethylene-vinyl acetate copolymer within a range from ≥40% by weight to ≤90% by weight, for example from ≥45% by weight or ≥50% by weight or ≥60% by weight or ≥65% by weight or ≥70% by weight to ≤90% by weight or ≤85% by weight or ≤80% by weight or a mixture or blend of two or more ethylene-vinyl acetate copolymers having different vinyl acetate contents each within a range from ≥40% by weight to ≤90% by weight, for example from ≥45% by weight or ≥50% by weight or ≥60% by weight or ≥65% by weight or ≥70% by weight to ≤90% by weight or ≤85% by weight or ≤80% by weight, based on the total weight of the ethylene-vinyl acetate copolymers.

In the context of a further embodiment, the polymer blend, based on the total weight of the polymers in the polymer blend, comprises ≥2% by weight to ≤60% by weight of the at least one further rubber, for example of natural rubber and/or butadiene rubber, especially in total. By way of example, the polymer blend, based on the total weight of the polymers in the polymer blend, may comprise ≥10% by weight to ≤50% by weight of the at least one further rubber, for example of natural rubber and/or butadiene rubber, especially in total. More particularly, the polymer blend, based on the total weight of the polymers in the polymer blend, may comprise ≥15% by weight to ≤40% by weight of the at least one further rubber, for example of natural rubber and/or butadiene rubber, especially in total. This has been found to be particularly advantageous for improvement of processibility, for example of extrudability, especially with maintenance of sufficiently good cold flexibility and wiping quality and sufficiently good damping properties and running properties, for example sufficiently good reduction in running noise, especially over a broad temperature and frequency range, especially for formation of the wiper rubber in the form of a hollow profile.

In the context of a further embodiment, the polymer blend, based on the total weight of the polymers in the polymer blend, comprises ≥10% by weight to ≤99.9% by weight of the at least one ethylene-propylene-diene rubber and/or ethylene-propylene rubber, especially in total. By way of example, the polymer blend, based on the total weight of the polymers in the polymer blend, may comprise ≥20% by weight or ≥30% by weight or ≥40% by weight or ≥50% by weight or ≥60% by weight or ≥70% by weight to ≤99.9% by weight or ≤95% by weight, optionally to ≤90% by weight or ≤85% by weight or ≤80% by weight, of the at least one ethylene-propylene-diene rubber and/or ethylene-propylene rubber, especially in total. This has been found to be particularly advantageous.

Especially if the polymer blend, aside from the at least one ethylene-propylene-diene rubber and/or ethylene-propylene rubber, comprises solely the at least one ethylene-vinyl acetate copolymer with the vinyl acetate content, based on the total weight of the at least one ethylene-vinyl acetate copolymer, within a range from ≥40% by weight to ≤90% by weight, the polymer blend, based on the total weight of the polymers in the polymer blend, may comprise, for example, ≥70% by weight to ≤99.9% by weight, by way of example ≥77% by weight to ≤99% by weight, for example ≥80% by weight or ≥85% by weight to ≤98% by weight, of the at least one ethylene-propylene-diene rubber and/or ethylene-propylene rubber, especially in total. This has been found to be particularly advantageous for the purpose.

If the polymer blend, in addition to the at least one ethylene-propylene-diene rubber and/or ethylene-propylene rubber and the at least one ethylene-vinyl acetate copolymer with the vinyl acetate content, based on the total weight of the at least one ethylene-vinyl acetate copolymer, within a range from ≥40% by weight to ≤90% by weight, comprises at least one further polymer, for example the at least one further rubber, the polymer blend, based on the total weight of the polymers in the polymer blend, may comprise, for example, ≥20% by weight to ≤95% by weight or ≤90% by weight, by way of example ≥30% by weight to ≤85% by weight, for example ≥40% by weight to ≤80% by weight, of the at least one ethylene-propylene-diene rubber and/or ethylene-propylene rubber, especially in total. This has been found to be particularly advantageous for the purpose.

In addition to the polymer blend, the elastomer material may comprise one or more additives, for example those customary for wiper rubber production. In the context of a further embodiment, the elastomer material, especially in addition to the polymer blend, further comprises at least one filler. For example, the elastomer material may comprise at least one black filler, for example carbon black, and/or at least one white filler, for example silicon dioxide and/or at least one silicate and/or kaolin and/or clay and/or chalk, for example calcium carbonate (CaCO₃). Optionally, the at least one filler may be used in combination with at least one silane, for example organosilane.

In the context of a further embodiment, therefore, the elastomer material, especially in addition to the polymer blend, further comprises at least one silane, for example organosilane. The at least one silane may be mixed here into the elastomer material and/or the at least one tiller and/or a combination of the at least one filler and the at least one silane that has already been provided by a filler manufacturer, for example, may be used, especially directly.

In the context of a further embodiment, the elastomer material further comprises at least one plasticizer and/or at least one oil.

In the context of a further embodiment, the elastomer material further comprises at least one vulcanizing agent and/or at least one vulcanizing auxiliary. For example, the elastomer material may comprise at least one peroxide, for example a combination of peroxides, as vulcanizing agent. The elastomer material here may comprise at least one vulcanizing auxiliary for peroxide vulcanization. Alternatively or additionally, the elastomer material may comprise sulfur and/or a sulfur-based system as vulcanizing agent. The elastomer material here may comprise at least one vulcanizing auxiliary for sulfur vulcanization, for example zinc oxide and/or stearic acid, et cetera.

In the context of a further embodiment, the elastomer material further comprises at least one antioxidant, by way of example at least one antiozonant, for example at least one antiozonant wax.

In the context of a further embodiment, the elastomer material further comprises at least one processing auxiliary. For example, the at least one processing auxiliary may comprise at least one fatty acid and/or at least one fatty acid derivative, for example at least one fatty acid ester and/or at least one fatty acid amide, for example at least one oleoamide and/or at least one erucamide, and/or at least one fatty alcohol and/or at least one fatty alcohol derivative, for example at least one fatty alcohol ester, et cetera, and/or a metal salt thereof and/or a combination thereof.

The components of the elastomer material can be mixed by the methods customary in wiper rubber production to give the elastomer material.

The wiper rubber may, for example, have been formed partly or entirely from the elastomer material.

In the context of a further embodiment, the wiper rubber comprises a wiper lip and a securing section. The securing section and/or the wiper lip here may have been formed from the elastomer material. For example, the securing section or the wiper lip or the securing section and the wiper lip of the wiper rubber may have been formed from the elastomer material.

The wiper rubber may have been formed, for example, by extrusion or by injection molding and/or injection-compression molding and/or compression molding, for example from the elastomer material, optionally in combination with at least one further elastomer material.

The wiper rubber may have been formed, for example, in the form of a hollow profile or solid profile.

With regard to further technical features and advantages of the wiper rubber of the invention, reference is hereby made explicitly to the elucidations in connection with the wiper blade of the invention and to the figures and the description of figures.

The invention further provides a wiper blade, especially for a windshield wiper, by way of example for a vehicle, for example for an automobile, comprising a wiper rubber of the invention.

With regard to further technical features and advantages of the wiper blade of the invention, reference is hereby made explicitly to the elucidations in connection with the wiper rubber of the invention and to the figures and the description of figures.

### BRIEF DESCRIPTION OF THE DRAWINGS

Further advantages and advantageous configurations of the subject matter of the invention are illustrated by the drawing and the working example and elucidated in the description which follows. It should be noted here that the drawing and the working example are merely of descriptive character and are not intended to limit the invention in any way at all. The drawing shows:

FIG. 1 shows a side view of a wiper blade according to the invention

FIG. 2 shows a schematic cross section, along line II-II in FIG. 1, showing only a wiper rubber of the invention.

### DETAILED DESCRIPTION

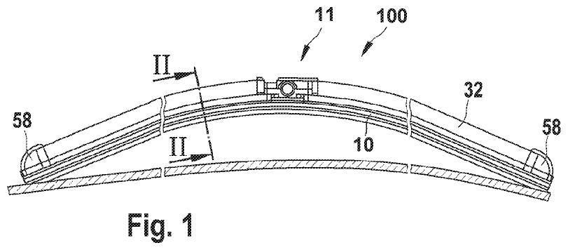

FIG. 1 shows a wiper blade 100 comprising a wiper rubber 10 and a spoiler 32. End caps 58 which limit the relative movability of the wiper rubber 10 and the spoiler 32 relative to one another in the longitudinal direction, are located at the ends of the wiper blade 10. A connecting element 11 is fastened to the wiper blade 100 in the central region of the wiper blade 100. The connecting element 11 serves for articulated connection to a wiper arm (not illustrated). The illustrated wiper blade 100 is only an example of a type of wiper blade that can be used in connection with the wiper rubber 10 of the invention.

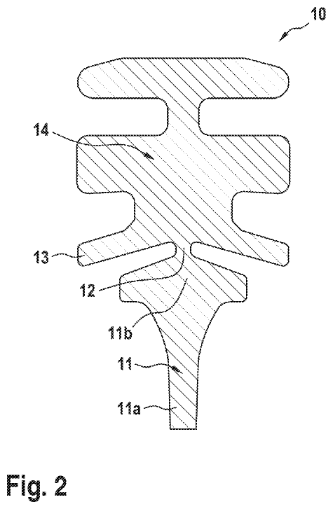

FIG. 2 shows an embodiment of the wiper rubber 10 of the invention. The wiper rubber 10 is configured for use with a wiper blade, for example for windshield wipers, such as shown in FIG. 1. The wiper rubber 10 comprises an elastomer material based on a polymer blend composed of at least one ethylene-propylene-diene rubber and/or at least one ethylene-propylene rubber, and at least one ethylene-vinyl acetate copolymer. This at least one ethylene-vinyl acetate copolymer, based on the total weight of the at least one ethylene-vinyl acetate copolymer, includes a vinyl acetate content within a range from ≥0% by weight to ≤90% by weight. The polymer blend here comprises, based on the total weight of the polymers in the polymer blend, ≥0.1% by weight to <30% by weight, by way of example ≥2% by weight to ≥20% by weight, of the at least one ethylene-vinyl acetate copolymer.

FIG. 2 shows that the wiper rubber 10 has a wiper lip 11 with a wiper lip tip 11a. and with a wiper lip wedge 11b, and also a tilting element 12 and a securing section 14 with brush strips 13. The wiper lip 11, especially the wiper lip wedge lib of the wiper lip 11, is connected here via the tilting element 12 to the brush strips 13 of the securing section 14. The securing section 14 is designed here for mounting of the wiper rubber 10 in a wiper blade rail and is in the form of a hollow profile.

The wiper rubber 10 here may, for example, have been formed partly or entirely from the elastomer material. For example, the wiper lip 11, for example the wiper lip tip 11a and/or the wiper lip wedge 11b of the wiper lip 11, and/or the tilting element 12 and/or the brush strips 13 and/or the securing section 14 may have been formed from the elastomer material.

### Working Examples

Working example series 1: Wiper rubbers made of EP(D)M-EVM polymer blends with a small amount of an EVM with a high vinyl acetate content

A series of wiper rubbers based on a series of polymer blends was extruded and vulcanized, which comprised, based on the total weight of the polymers in the polymer blend, ≥70% by weight to ≤99.9% by weight of ethylene-propylene-diene rubber and/or ethylene-propylene rubber (EP(D)M) and ≥0.1% by weight to <30% by weight of ethylene-vinyl acetate copolymer (EVM) with a vinyl acetate content based on the total weight of the at least one ethylene-vinyl acetate copolymer within a range from ≥40% by weight to ≤90% by weight.

Working example series 2: Wiper rubbers made of EP(D)M-EVM-NR/BR/SBR/IR polymer blends with a small amount of an EVM with a high vinyl acetate content

A series of wiper rubbers based on a series of polymer blends was extruded and vulcanized, which comprised, based on the total weight of the polymers in the polymer blend, ≥40% by weight to ≤180% by weight of ethylene-propylene-diene rubber and/or ethylene-propylene rubber (EP(D)M), ≥0.1% by weight to <30% by weight of ethylene-vinyl acetate copolymer (EVM) with a vinyl acetate content based on the total weight of the at least one ethylene-vinyl acetate copolymer within a range from ≥40% by weight to ≤90% by weight and ≥2% by weight to ≤60% by weight of at least one further rubber, for example natural rubber and/or butadiene rubber and/or styrene-butadiene rubber and/or isoprene rubber. It was possible here to extrude the wiper rubbers in the form of hollow profiles.

The damping properties and cold flexibility of the wiper rubbers according to working example series 1 and 2 were measured by means of dynamic-mechanical analysis at different temperatures and frequencies.

The measurements showed that, by adding just a small amount of ethylene-vinyl acetate copolymer having a high vinyl acetate content and/or natural rubber/butadiene rubber/styrene-butadiene rubber/isoprene rubber, it was advantageously possible, in the dynamic-mechanical analysis within a frequency range from 0.001 Hz to 300 Hz, to achieve a tangent delta value representative of the damping properties of more than 0.20, especially of ≥0.24, for example of ≥0.25, in some cases even of ≥0.30. It was thus possible to at least maintain or especially even improve the tangent delta value and hence the damping properties compared to ethylene-propylene(-diene) rubber (EP(D)M) having a tangent delta value at 300 Hz of about 0.20 or less.

When the tangent delta values were plotted against frequency and/or temperature, there was advantageously barely any shift or no shift in a main peak representative of the cold flexibility and or glass transition temperature to higher temperatures and/or to lower frequencies, especially by contrast with polymer blends composed of ethylene-propylene(-diene) rubber (EP(D)M) and ≥30% by weight to ≤60% by weight of ethylene-vinyl acetate copolymer (EVM) with a vinyl acetate content based on the total weight of ethylene-vinyl acetate copolymer within a range from ≥45% by weight to ≤85% by weight.

It was thus possible through the addition of just a small amount of ethylene-vinyl acetate copolymer having a high vinyl acetate content, especially also in the presence of at least one further polymer, for example at least one further rubber, such as natural rubber and/or butadiene rubber and/or styrene-butadiene rubber and/or isoprene rubber, to at least sufficiently reduce or even prevent unwanted running noise, such as humming, whistling, squeaking, smacking, turnover noises, et cetera, over a broad temperature range including both moderate and cold outside temperatures, and, for example, also over a broad frequency range including frequencies customary in wiper operation.

1. A wiper rubber (10) for a wiper blade, the wiper rubber comprising an elastomer material comprising a polymer blend composed of at least one ethylene-propylene-diene rubber and/or at least one ethylene-propylene rubber, and at least one ethylene-vinyl acetate copolymer,
wherein the at least one ethylene-vinyl acetate copolymer, based on the total weight of the at least one ethylene-vinyl acetate copolymer, comprises a vinyl acetate content within a range from ≥40% by weight to ≤90% by weight,
wherein the polymer blend, based on the total weight of the polymers in the polymer blend, comprises ≥0.1% by weight to <30% by weight of the at least one ethylene-vinyl acetate copolymer.

2. The wiper rubber (10) according to claim 1, wherein the polymer blend, based on the total weight of the polymers in the polymer blend, comprises ≥2% by weight to ≤20% by weight of the at least one ethylene-vinyl acetate copolymer.

3. The wiper rubber (10) according to claim 1, wherein the at least one ethylene-vinyl acetate copolymer, based on the total weight of the at least one ethylene-vinyl acetate copolymer, comprises a vinyl acetate content within a range from ≥50% by weight to ≤90% by weight.

4. The wiper rubber (10) according to claim 1, wherein the at least one ethylene-vinyl acetate copolymer, based on the total weight of the at least one ethylene-vinyl acetate copolymer, comprises a vinyl acetate content within a range from ≥65% by weight to ≤90% by weight.

5. The wiper rubber (10) according to claim 1, wherein the polymer blend further comprises at least one further rubber.

6. The wiper rubber (10) according to claim 5, wherein the at least one further rubber comprises or is natural rubber and/or butadiene rubber and/or styrene-butadiene rubber and/or isoprene rubber.

7. The wiper rubber (10) according to claim 5, wherein the polymer blend, based on the total weight of the polymers in the polymer blend, comprises ≥2% by weight to ≤60% by weight of the at least one further rubber.

8. The wiper rubber (10) according to claim 1, wherein the polymer blend, based on the total weight of the polymers in the polymer blend, comprises ≥10% by weight to ≤99.9% by weight of the at least one ethylene-propylene-diene rubber and/or ethylene-propylene rubber.

9. The wiper rubber (10) according to claim 1, wherein the polymer blend, based on the total weight of the polymers in the polymer blend, comprises ≥40% by weight to ≤80% by weight of the at least one ethylene-propylene-diene rubber and/or ethylene-propylene rubber.

10. The wiper rubber (10) according to claim 1, wherein the elastomer material further comprises
at least one filler and/or
at least one silane and/or
at least one plasticizer and/or
at least one oil and/or
at least one vulcanizing agent and/or
at least one vulcanizing auxiliary and/or
at least one antioxidant and/or
at least one processing auxiliary.

11. The wiper rubber (10) according to claim 1, wherein the wiper rubber (10) has a wiper (11) and a securing section (14), wherein the securing section (14, 13) and/or the wiper lip (11) is formed from the elastomer material.

12. A wiper blade, especially for a windshield wiper, comprising a wiper rubber (10) according to claim 1.

13. The wiper rubber (10) according to claim 1, wherein the wiper rubber is configured for use with a windshield wiper.

14. The wiper rubber (10) according to claim 1, wherein the polymer blend, based on the total weight of the polymers in the polymer blend, comprises ≥2% by weight to ≤15% by weight of the at least one ethylene-vinyl acetate copolymer.

15. The wiper rubber (10) according to claim 1, wherein the at least one ethylene-vinyl acetate copolymer, based on the total weight of the at least one ethylene-vinyl acetate copolymer, comprises a vinyl acetate content within a range from ≥60% by weight to ≤90% by weight.

16. The wiper rubber (10) according to claim 1, wherein the at least one ethylene-vinyl acetate copolymer, based on the total weight of the at least one ethylene-vinyl acetate copolymer, comprises a vinyl acetate content within a range from ≥70% by weight to ≤80% by weight.

17. The wiper rubber (10) according to claim 5, wherein the polymer blend, based on the total weight of the polymers in the polymer blend, comprises ≥15% by weight to ≤40% by weight of the at least one further rubber.

18. The wiper rubber (10) according to claim 1, wherein the polymer blend, based on the total weight of the polymers in the polymer blend, comprises ≥20% by weight to ≤95% by weight of the at least one ethylene-propylene-diene rubber and/or ethylene-propylene rubber.

19. The wiper rubber (10) according to claim 1, wherein the polymer blend, based on the total weight of the polymers in the polymer blend, comprises ≥30% by weight to ≤95% by weight, of the at least one ethylene-propylene-diene rubber and/or ethylene-propylene rubber in total.

20. The wiper rubber (10) according to claim 1, wherein the polymer blend, based on the total weight of the polymers in the polymer blend, comprises ≥40% by weight to ≤80% by weight of the at least one ethylene-propylene-diene rubber and/or ethylene-propylene rubber in total.
